(19) United States
(12) Patent Application Publication
(10) Pub. No.: US 2012/0044220 A1
(43) Pub. Date: Feb. 23, 2012

(54) METHOD OF FORMING MULTILAYER CONDUCTOR LINE, AND ELECTRONIC PAPER PANEL USING THE SAME

(75) Inventors: Jae Chan LEE, Gyeonggi-do (KR); Hyun Hak Kim, Gyeonggi-do (KR); Gi Young Byun, Incheon (KR)

(73) Assignee: SAMSUNG ELECTRO-MECHANICS CO., LTD.

(21) Appl. No.: 12/962,237

(22) Filed: Dec. 7, 2010

(30) Foreign Application Priority Data
Aug. 18, 2010 (KR) 10-2010-0079830

(51) Int. Cl. G09G 5/00; H01J 9/24

(52) U.S. Cl. 345/205; 445/24

(57) ABSTRACT

Disclosed herein are a method of forming a multilayer conductor line and an electronic paper panel using the same. The electronic paper panel includes a substrate: a lower electrode disposed on the upper portion of the substrate and formed with a wiring layer to electrically connect each of the segments so that it drives an electronic paper; an upper electrode disposed on the upper portion of the lower electrode to display information to be represented; an insulating layer disposed between the upper electrode and the lower electrode; a driving chip mounted on the upper surface of the lower electrode, whereby the conductor lines can be designed in the multilayer structure type at the time of forming the conductor lines of the electronic paper panel, such that it is possible to variously design the conductor lines even though the substrate size is small.

### CROSS REFERENCE TO RELATED APPLICATION

This application claims the benefit under 35 U.S.C. Section [120, 119, 119(e)]of Korean Patent Application Serial No. 10-2010-0079830, entitled “Method Of Forming Multilayer Conductor Line And Electronic Paper Panel Using The Same”, filed on Aug. 18, 2010, which is hereby incorporated by reference in its entirety into this application.

### BACKGROUND OF THE INVENTION

1. Technical Field

The present invention relates to a method of forming a multilayer conductor line and an electronic paper using the same, and more particularly, to a method of forming a multilayer conductor line capable of improving a degree of freedom in a design for a conductor line width by applying a multilayer structure when forming a conductor line of an electronic paper panel and an electronic paper panel using the same.

2. Description of the Related Art

The number of discount stores and large-scale distribution stores has been increased at home and abroad. Generally, stores have used paper to indicate a price in most cases. Recently, however, an electronic shelf label (TAG) has been increasingly used in stores in Europe. Some stores in domestic have used the electronic shelf label. In particular, some customers have requested a display having the same texture as paper when using the electronic shelf label tag.

An attempt to use an electronic shelf label tag using an electronic paper, such as E-ink, or the like, has been made.

Some customers want to display a variety of information on a predetermined display area, but a passive segment type or an active graphic type such as e-Book is applicable when considering electronic paper characteristics. In particular, in the case of the passive type, a conductor line (pin map) having a one-to-one correspondence relationship with each segment should be formed in order to turn-on/off the defined information.

In this case, even though information can be arranged on the display surface, a design is restricted if it is impossible to form the conductor line. In the case where the arranged conductor lines intersect with each other or the short phenomenon occurs at the time of designing the conductor line (pin map), the reason is that it may cause information transfer errors by displaying unwanted information due to the problem of simultaneously turning-on/off a plurality of segments.

For example, as described with reference to FIGS. 1 to 4, a lower pin map 11 structure of an electronic paper panel 10 of FIG. 1 undergoes a mapping design so that the conductors do not intersect with each other.

Meanwhile, when a large amount of information to be represented as shown in FIG. 2 is much and a space in which the conductor line for the pin map will be designed is lack (FIGS. 3 and 4), the design of the segment type cannot be formed, such that a method of increasing a display area should be applied.

For example, as described with reference to FIGS. 2 to 4, numbers of an A area of the electronic paper panel 10 are spaced by a B interval in consideration of the pin map. If the conductor line for the pin map is designed in the corresponding area as shown in FIG. 4, there is a problem in that a path through which the conductor line for the area except for the A area passes is removed.

In order to solve the above-mentioned problem, since there is a need to increase the display area and widen the interval spaced between characters according to the pin map design regardless of the design to be displayed, there is a problem in that the desired design cannot be represented on the electronic paper.

### SUMMARY OF THE INVENTION

An object of the present invention is to provide a method of forming a multilayer conductor line capable of improving the freedom in design of a conductor line by applying a multilayer structure type and reducing a substrate size, at the time of forming conductor lines of an electronic paper panel and an electronic paper panel using the same.

According to an exemplary embodiment of the present invention, there is provided an electronic paper panel, including: a substrate: a lower electrode disposed on the upper portion of the substrate and formed with a wiring layer to electrically connect each of the segments to each other so that it drives an electronic paper; an upper electrode disposed on the upper portion of the lower electrode; an insulating layer disposed between the upper electrode and the lower electrode; and a driving chip mounted on the upper surface of the lower electrode.

The insulating layer may be disposed in a region in which the upper electrode and the lower electrode overlap with each other.

The electronic paper panel may further include a via hole electrically connecting the upper electrode to the lower electrode.

The substrate may be made of glass-based soda lime glass, borosilicate glass, alkali-free glass in addition to polyethylene teraphthalate (PET), polycarbonate (PC), polyethersulfone (PES), polyimide, polynorbornene, polyarylate (PAR), polyetheretherketone (PEEK), polyethylenenaphthalate, polyetherimide (PEI) and a combination thereof.

The circuit configuration of the lower electrode may be formed as an electrode made of tin oxide (SnO₂), indium tin oxide, carbon, silver, copper, and a combination thereof.

The insulating layer may be made of insulating paste, in addition to glass paste, insulating UV curing ink, paste for solder resistor, and a combination thereof.

The upper electrode may be made of carbon paste, silver, copper paste (Cu paste), and a combination thereof, all of which are used at approximately 150° C.

The electronic paper panel may further include a flexible printed circuit board (FPCB) disposed on the upper surface of the substrate.

According to another exemplary embodiment of the present invention, there is provided a method of forming a multilayer conductor line, including: forming a lower electrode including a wiring layer on a substrate; forming an insulating layer on the upper surface of the lower electrode; forming an upper electrode on the insulating layer; and mounting a driving chip on the upper surface of the lower electrode.

At the forming the insulating layer, the insulating may be formed to be disposed in a region in which the upper electrode and the lower electrode overlap with each other.

The method of forming a multilayer conductor line may further include a via hole electrically connecting the upper electrode to the lower electrode.

In the electronic paper panel, electrode wirings and a circuit configuration may be formed by a screen printing method, an dry or wet etching method of photolithograph, wherein the wiring is formed at 60 μm or less by using a depositing or printing process.

The conductor of the upper electrode may be formed to have the viscosity of 200 cps to 100000 cps.

The paste used when the conductor and the insulating layer of the upper electrode 150 are formed may be dried for 10 to 30 minutes approximately 150° C.

### BRIEF DESCRIPTION OF THE DRAWINGS

FIG. 1 is a plan view showing a lower pin map structure of an electronic paper panel according to the related art;

FIG. 2 is a plan view of the electronic paper panel according to the related art;

FIG. 3 is a plan view showing a portion of the electronic paper panel of FIG. 2;

FIG. 4 is a plan view showing in detail a pin map structure of a portion of the electronic paper panel of FIG. 3;

FIG. 5 is a plan view showing an example of an upper electrode according to the present invention;

FIG. 6 is a plan view showing an example of a lower electrode according to the present invention;

FIG. 7 is a cross-sectional view of an electronic paper panel according to the present invention; and

FIG. 8 is a diagram for explaining a method of forming a multilayer conductor line of an electronic paper panel according to the present invention.

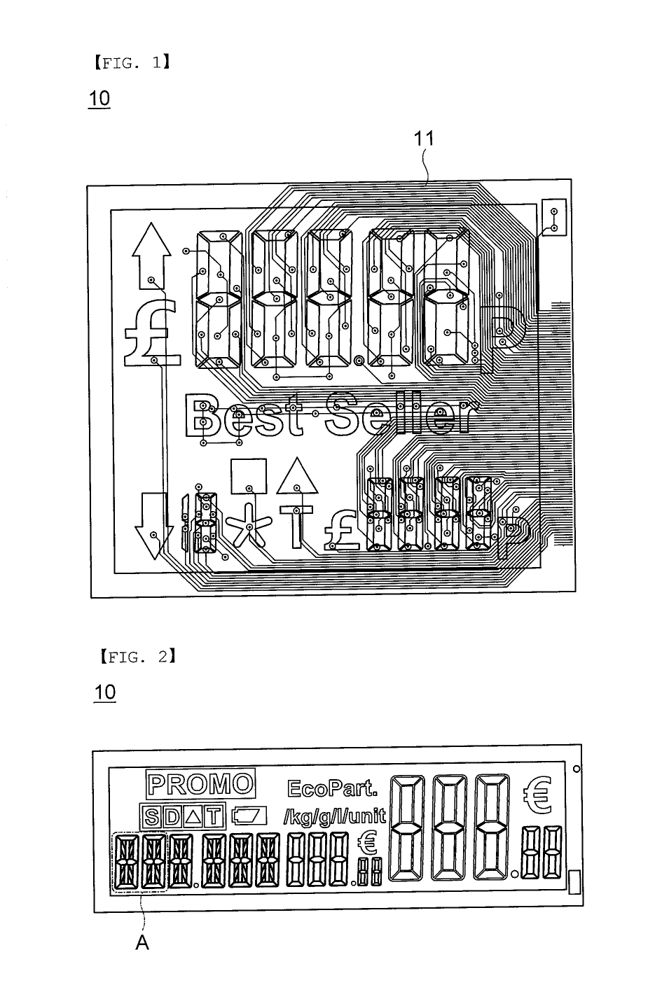

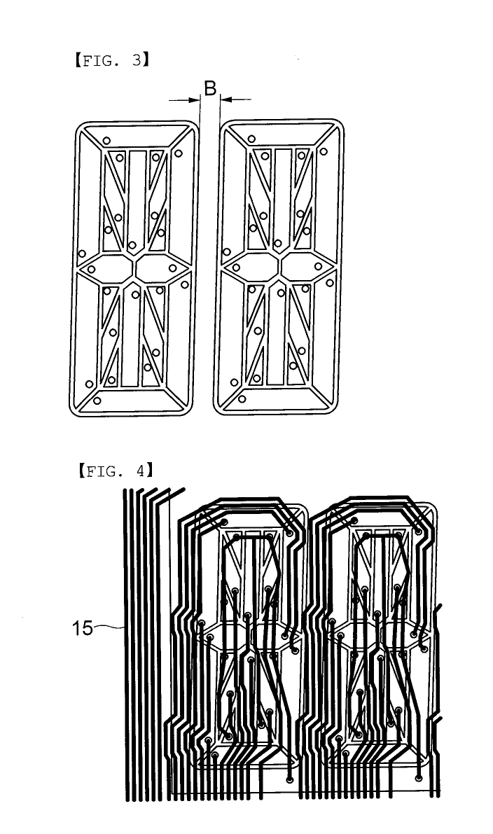

### DESCRIPTION OF THE PREFERRED EMBODIMENTS Hereinafter, exemplary embodiments of the present invention will be described in detail with reference to an electronic paper panel.

Therefore, the present invention may be modified in many different forms and it should not be limited to the embodiments set forth herein. In the drawings, the size and the thickness of the device may be exaggerated for convenience. Like reference numerals designate like components throughout the specification.

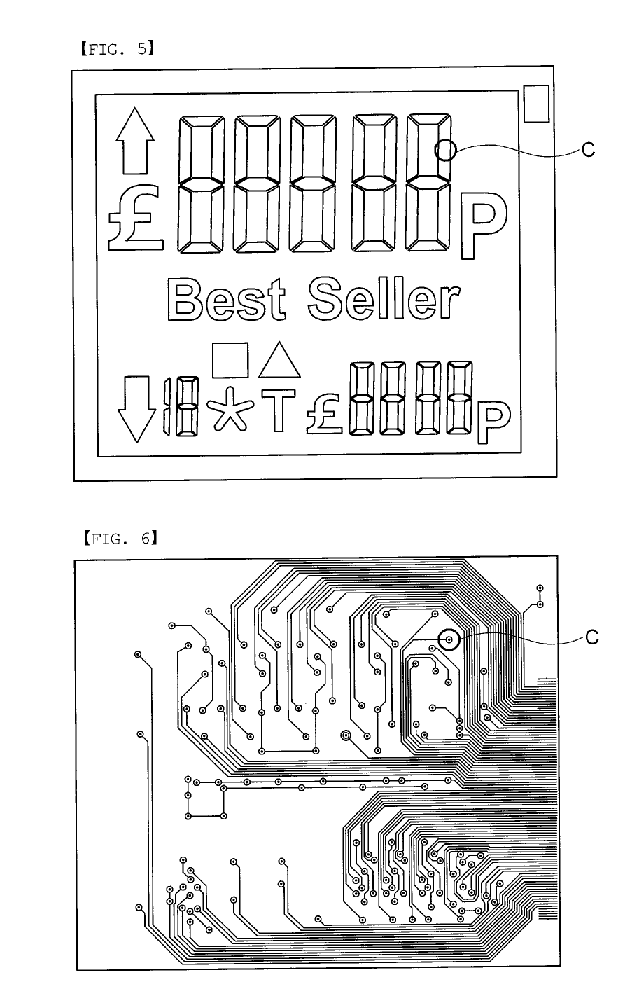

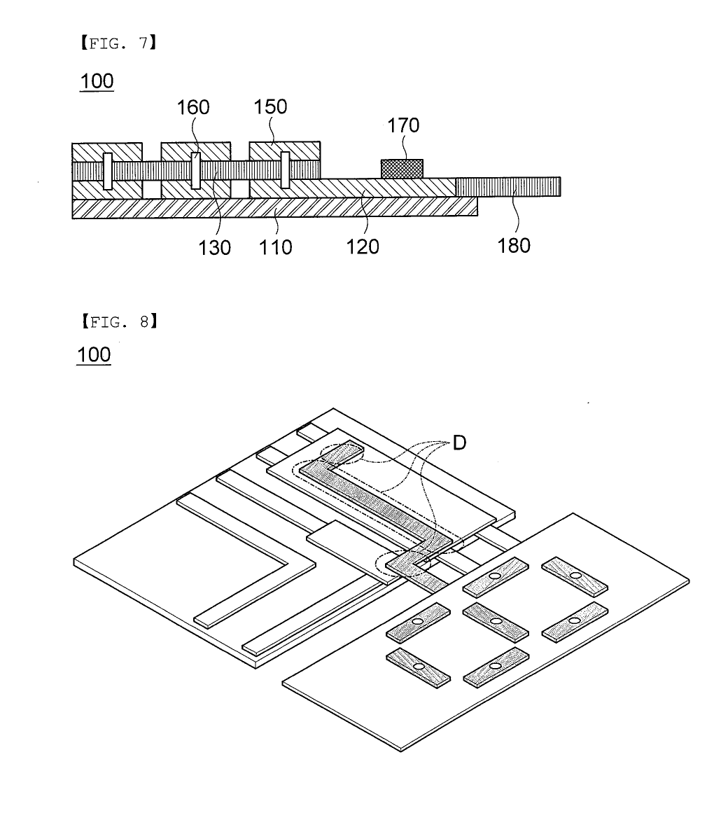

FIG. 5 is a plan view showing an example of an upper electrode according to the present invention, FIG. 6 is a plan view showing an example of a lower electrode according to the present invention, FIG. 7 is a cross-sectional view of an electronic paper panel according to the present invention; and FIG. 8 is a diagram for explaining a method of forming a multilayer conductor line of an electronic paper panel according to the present invention.

As shown, an electronic paper panel 100 includes a substrate 110, a lower electrode 120, an insulating layer 130, an upper electrode 150, a via hole 160, a driving chip 170, and a flexible circuit board (FPCB) 180.

Describing in more detail, the substrate 110 may be made of glass-based soda lime glass, borosilicate glass, alkali-free glass in addition to polyethylene teraphthalate (PET), polycarbonate (PC), polyethersulfone (PES), polyimide, polynorbornene, polyarylate (PAR), polyetheretherketone (PEEK), polyethylenenaphthalate, and polyetherimide (PEI), and a combination thereof.

The lower electrode 120 is disposed on the upper portion of the substrate and is provided with the wiring layer to electrically connect each segment, such that it may be formed to drive the electronic paper.

As shown in FIG. 6, it can be confirmed that the conductor lines for the pin map are designed in the lower electrode 120.

Meanwhile, the circuit configuration of the lower electrode 120 may be formed as an electrode made of tin oxide (SnO₂), indium tin oxide, carbon, silver, copper, and a combination thereof.

The upper electrode 150 is disposed on the upper portion of the lower electrode 120, thereby making it possible to display information to be represented.

As shown in FIG. 5, the upper electrode 150 serves to output characters, etc., which can be confirmed with the naked eye of a user, on the surface of the electronic paper.

In this configuration, the upper electrode 150 may be made of carbon paste, silver, copper paste (Cu paste), and a combination thereof, all of which may be used before and after 150° C.

The insulating layer 130 may be disposed between the upper electrode 150 and the lower electrode 120.

In this case, the insulating layer 130 may be disposed in a region in which the upper electrode 150 and the lower electrode 120 overlap with each other.

The insulating layer 130 is to serve to insulate between the upper electrode 150 and the lower electrode 120. That is, the insulating layer 130 is to insulate the mutual conductor for a specific portion at the time of printing the electronic paper. As described above, the present invention can obtain an effect of reducing the unnecessary substrate size and achieve various designs without considering the pin map design due to the multilayer structure in which the upper electrode and the lower electrode are disposed to overlap with each other.

In addition, the insulating layer 130 may be made of insulating paste, in addition to glass paste, insulating UV curing ink, paste for solder resistor, and a combination thereof.

The via hole 160 may be formed to connect the upper electrode 150 to the lower electrode 120.

For example, as shown in FIGS. 5 to 7, the via hole 160 connects a C point of the lower electrode of FIG. 6 corresponding to a C point of the upper electrode of FIG. 5 as shown in FIG. 7, thereby making it possible to electrically connect the C points to each other.

The driving chip 170 may be mounted on the upper surface of the lower electrode 120.

The electronic paper panel 100 may further include a flexible printed circuit board (FPCB) disposed on the upper surface of the substrate 110.

Hereinafter, a method of forming a multilayer conductor line of an electronic paper panel will be described with reference to the drawings.

First, the lower electrode 120 including a wiring layer may be formed on the substrate 110.

Thereafter, the insulating layer 130 may be formed on the upper surface of the lower electrode 120.

In this case, the insulating layer 130 may be formed so that the insulating layer 130 is disposed in the region (D of FIG. 8) in which the upper electrode 150 and the lower electrode 120 overlap with each other.

Further, the paste used when the conductor and the insulating layer of the upper electrode 150 are formed may be dried for 10 to 30 minutes before and after 150° C.

Thereafter, the upper electrode 150 may be formed on the insulating layer 130.

In this case, the conductor of the upper electrode 150 may be formed to have the viscosity of 200 cps to 100000 cps.

Meanwhile, the via hole 160 may be formed to connect the upper electrode 150 to the lower electrode 120.

In this case, the method of forming the via hole 160 may be applied with a general method known in the related art.

The driving chip 170 may be mounted on the upper surface of the lower electrode 120.

Meanwhile, although not shown, in the electronic paper panel 100 disclosed in the present invention, the electrode wirings and the circuit configuration may be formed by a screen printing method, an dry or wet etching method of photolithograph, wherein the wiring can be formed on the upper surface of the substrate at 60 μm or less by using a depositing or printing process.

The present invention can obtain the same effect as the multilayer PCB by applying the simple printing scheme while maintaining the level corresponding to the process line width (for example, 80 μm or more) required during the process of the existing PCB. An example of the material of the substrate may include PCB, PI, or PET, PEN, glass material.

In this case, the insulating layer (for example, non-conductive material such as solder resistor or UV ink, etc.) is formed between the upper electrodes, the pattern is formed in a manner of insulating between the mutual conductors by performing the insulating processing on the specific portions (short or pin map crossing portion) once more at the time of printing to form a pattern, and carbon paste, silver paste, or Cu paste is applied to the upper electrode to conduct the upper and lower electrodes between the vias. Thereby, the present invention can increase the freedom in design of the conductor line width, thereby making it possible to remarkably reduce the substrate size.

According to the exemplary embodiments of the present invention, the method of forming the multilayer conductor line and the electronic paper panel using the same can design the conductor lines in the multilayer structure type at the time of forming the conductor lines of the electronic paper panel, such that it is possible to variously design the conductor lines even though the substrate size is small.

Further, the present invention can design the conductor lines in the multilayer structure, thereby making it possible to reduce the substrate size as compared to the related art.

Further, the present invention can obtain the same effect as the multilayer printed circuit board by applying the simple printing scheme while maintaining the level corresponding to the process line width required during the process of the existing printed circuit board.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An electronic paper panel, comprising:
a substrate:
a lower electrode disposed on the upper portion of the substrate and formed with a wiring layer to electrically connect each of the segments so that it drives an electronic paper;
an upper electrode disposed on the upper portion of the lower electrode to display information to be represented;
an insulating layer disposed between the upper electrode and the lower electrode; and
a driving chip mounted on the upper surface of the lower electrode.

2. The electronic paper panel according to claim 1, wherein the insulating layer is disposed in a region in which the upper electrode and the lower electrode overlap with each other.

3. The electronic paper panel according to claim 2, further comprising a via hole electrically connecting the upper electrode to the lower electrode.

4. The electronic paper panel according to claim 3, wherein the substrate is made of glass-based soda lime glass, borosilicate glass, alkali-free glass in addition to polyethylene teraphthalate (PET), polycarbonate (PC), polyethersulfone (PES), polyimide, polynorbornene, polyarylate (PAR), polyetheretherketone (PEEK), polyethylenenaphthalate, and polyetherimide(PEI), and a combination thereof.

5. The electronic paper panel according to claim 4, wherein the circuit configuration of the lower electrode is formed as an electrode made of tin oxide (SnO₂), indium tin oxide, carbon, silver, copper, and a combination thereof.

6. The electronic paper panel according to claim 5, wherein the insulating layer is made of insulating paste, in addition to glass paste, insulating UV curing ink, paste for solder resistor, and a combination thereof.

7. The electronic paper panel according to claim 6, wherein the upper electrode is made of carbon paste, silver, copper paste (Cu paste), and a combination thereof, all of which are used before and after 150° C.

8. The electronic paper panel according to claim 7, further comprising a flexible printed circuit board (FPCB) disposed on the upper surface of the substrate.

9. A method of forming a multilayer conductor line of an electronic paper panel, comprising:
forming a lower electrode including a wiring layer on a substrate;
forming an insulating layer on the upper surface of the lower electrode;
forming an upper electrode on the insulating layer; and
mounting a driving chip on the upper surface of the lower electrode.

10. The method of forming a multilayer conductor line of an electronic paper panel according to claim 9, wherein at the forming the insulating layer, the insulating layer is formed to be disposed in a region in which the upper electrode and the lower electrode overlap with each other.

11. The method of forming a multilayer conductor line of an electronic paper panel according to claim 10, further comprising forming a via hole electrically connecting the upper electrode to the lower electrode.

12. The method of forming a multilayer conductor line of an electronic paper panel according to claim 11, wherein in the electronic paper panel, electrode wirings and a circuit configuration are formed by a screen printing method, an dry or wet etching method of photolithograph, the wiring being formed on the upper surface of the substrate at 60 μm or less by using a depositing or printing process.

13. The method of forming a multilayer conductor line of an electronic paper panel according to claim 12, wherein the conductor of the upper electrode is formed to have the viscosity of 200 cps to 100000 cps.

14. The method of forming a multilayer conductor line of an electronic paper panel according to claim 13, wherein the paste used when the conductor and the insulating layer of the upper electrode are formed is dried for 10 to 30 minutes before and after 150° C.
